(19) United States
(12) Patent Application Publication
(10) Pub. No.: US 2013/0154216 A1
(43) Pub. Date: Jun. 20, 2013

(54) SYSTEM FOR MOBILIZING STOCKED SHELVING

(71) Applicants: Joseph Paulk, SR., Jacksonville, FL (US); William Thompson, Perry, FL (US); Troy Thompson, Perry, FL (US)

(72) Inventors: Joseph Paulk, SR., Jacksonville, FL (US); William Thompson, Perry, FL (US); Troy Thompson, Perry, FL (US)

(73) Assignee: Mobex of North Florida, Inc., Jacksonville, FL (US)

(21) Appl. No.: 13/528,270

(22) Filed: Jun. 20, 2012

Related U.S. Application Data
(60) Provisional application No. 61/498,726, filed on Jun. 20, 2011.

(51) Int. Cl. B62B 3/00

(52) U.S. Cl. CPC B62B 3/002
USPC 280/79.11

(57) ABSTRACT

A shelving mobilization assembly comprises a support adjustably retained within a channel formed in a pair of castor assemblies, the pair of castor assemblies each include an integrally formed U-shaped cross section between a plurality of castors. The support fits in the channel, and each end of the support and each of the pair of castor assemblies incorporate an interlocking tab and slots arranged such that the interlocking tab engages one of the slots, when the support fits in the channel of each of the pair of castor assemblies. The interlocking tab and corresponding slot adjustably retains the support in the channels of each of the pair of castor assemblies, such that the length between the pair of castor assemblies is defined at a fixed length, when the shelving is supported by the support. A tie-bar is capable joining one shelving mobilization assembly to a neighboring shelving mobilization assembly to maintain a fixed spacing between the one shelving mobilization assembly and the neighboring shelving mobilization assembly.

### RELATED APPLICATION

This application claims priority to U.S. Provisional Patent Application 61/498,726 filed on Jun. 20, 2011, which is incorporated by reference herein in its entirety.

### FIELD OF THE INVENTION

The field relates to mobilization systems for gondolas and other types of shelving used in retail stores and warehouses.

### BACKGROUND

Within the context of this specification, gondola, gondola run, gondolas and gondola islands all refer to store shelving known in the field. Gondolas are known with or without a central support column and with one or two sides having shelving attached. Warehouse pallet racking is also known, such as pallet racking used in home centers and warehouses. Unless otherwise expressly indicated, the term gondolas refer to both a single gondola and a gondola run having a plurality of gondolas or both.

Lifting systems are known that use a plurality of caster wheels to mobilize empty gondolas or gondolas that have at least a portion of the racked products removed from the gondolas. U.S. Patent Publication 2007/0194546, published Aug. 23, 2007, and U.S. Patent Publication 2007/0059138, published Mar. 15, 2007 illustrate systems with a screw or hydraulic jack for lifting gondolas, the description and drawings of which are hereby incorporated for background herein. Two devices are disposed on opposite sides of the gondolas at each upright support, which may be accessible behind a kick plate. Each upright support is raised using the lifting apparatus and the gondola, even if quite long, is movable using the lifting system as a hand truck, with each of the hand trucks being moved at the same time.

However, deep gondolas and gondolas with products displayed on the shelves racked on the gondolas cannot be moved using these known devices. An upright support in the middle of a gondola, between two opposite sides of the gondola, bows excessively, causing damage to the gondola support structure and tumbling of the products. Thus, a time consuming product remount and disassembly of the gondola unracking and reracking of at least a significant portion of the products on the gondolas is required in order to mobilize the gondolas.

U.S. patent application Ser. No. 12/364,177, the disclosure of which is incorporated herein, teaches a system for mobilization of stocked gondolas that allows for mobilization without removing shelving and without removing the products from the shelving of the gondolas or pallet racking. The system described a lifting mechanism attachable an H-support or other upright support of pallet racking, such as for use in mobilization of the pallet racking, but only from an exposed front or side of the H-support. Using the system for mobilizing a gondola permits even very deep and very wide gondolas to be mobilized, without unracking and/or disassembly of the gondolas and/or removal of product from the shelves, when a pair of opposing members are positioned such that the members extend along the depth of the gondola from one side to an opposite side. Each pair of opposing members is positioned such that the pair of members is disposed on opposite sides of a gondola support. A slidable middle lift bracket on each of the pair of opposing members is positioned at the middle, upright support of the gondola, and may have additional lift brackets disposed at other upright support members of the gondola. An interlinking tongue and loop system may be used to slide under the supports and to engage one lift bracket to its opposite lift bracket. Thus, the pair of opposing members may provide rigid support to the gondola, when the pair of opposing members are lifted, allowing for mobilization of the gondola. In this system, a modified jack engaged each end of each of the opposing members, such as a screw or hydraulic mechanism coupled with a pair of forks capable of engaging the pair of opposing members, such that the forks raise and lower the pair of opposing members together, at the same time. The forks are fixed in position and are not capable of displacement to make positioning of the jack in narrow inaccessible spaces.

In one example, a hand crank, such as a hand crank and screw similar to that of a boat trailer hitch apparatus, is used to lift a pair of forks inserted into the opposing members. A screw and hand crank is capable of replacing a heavier, more expensive and harder to maintain hydraulic jack, for example, when a plurality of such lift mechanisms are coupled to opposite ends of a plurality of the support apparatuses spaced at intervals along a gondola run. No single lift mechanism is required to exceed its rated lifting potential. The lack of any significant sagging from one side of the gondola reduces the height that the lift must raise the gondola to mobilize it, because the support bar is capable of supporting the supporting structure of the gondola a plurality of support points, such as three or more support points. In some of the examples, three support points are disclosed, but additional support points may be added in other applications requiring support of larger spans, for example.

Single sided gondolas and islands may be raised and lowered similarly to the double sided gondolas provided in the examples. In single sided gondolas, a support bar may be supported on only one side by a lift mechanism or on both sides. If supported on only one side by a lift mechanism, then other end of the support bar may be unsupported, requiring a counterbalance on the lift mechanism, or may be provided with a low-profile caster wheel that provides a fulcrum at an opposite end of the support bar assembly for lifting of the gondola during raising of the end of the support bar assembly attached to the lift mechanism, for example. In this way, a gondola having one side against a wall may be mobilized, for example, using a plurality of lift mechanisms along the side of the gondola facing away from the wall, only, while the low-profile casters inserted into or onto the support bar assemblies allow the support bar assemblies to be inserted and aligned under the gondolas.

Instead of forks, other structures are suggested to mount the lifting apparatus to the support structures used in lifting of the gondolas or to the gondolas, themselves. These other structures may be grabs, bolts or fingers, for example. Grabs are L-shaped extensions from a surface of the lift mechanism that are capable of engaging slots in a coupling mechanism or a gondola. For example, forks may be attached to an attachment member having slots that engage the grabs, allowing the forks to be positioned in the ends of the gondola support bars prior to engaging the lift apparatus to the forks. Then, the lift apparatus may be positioned such that the grabs engage the slots in the attachment member of the forks, and the lift apparatus may be raised until the grabs firmly engage in the slots prior to raising the gondolas. Bolts are fasteners extending from the lift mechanisms that are coupled with nuts or plates having a threaded or other coupling mechanism for attachment to the bolts when inserted through a hole or slot in the gondolas or the attachment member of the forks, for example. Fingers are projections, shaped or straight that matingly engage the gondola or the attachment member of the forks, for example. Thus, when properly engaged to the supports or the gondolas, the lift mechanism provides for a positive displacement upward and downward. However, these other structures did not suggest the use of any structures capable of moving, pivotally, while remaining engaged to the lift mechanism.

Shelving used in warehouses, superstores, consumer retail clubs and home improvement stores cannot be moved using a lifting bar mechanism. Furthermore, these types of shelves are usually positioned back-to-back to form aisles with little space between the shelves, making it difficult to insert any known lifting mechanism between the shelves. Instead, only the sides of the shelving are accessible for coupling to the jacks described in a Mobilization System for Lifting and Mobilization of Gondolas.

### SUMMARY

A system for mobilizing stocked shelving includes a plurality of castors attached by a shelf support member or members. For example, a first castor pad having a plurality of castors is removably attached at one end of a support member, and a second castor pad having a plurality of castors is removably attached at an opposite end of the support member. In one example, a support member is a C-shaped beam having an attachment mechanism disposed on each of its two opposite ends. For example, the C-shaped beam may be attached using a tab disposed at each of its two opposite ends that fits matingly into one of a plurality of slits or slots in each of the first and second castor pads, allowing two castor pads and the support beam to form a rolling support that is extendable adjustably in length.

For example, the slots or slits may be formed in a bottom surface of a channel extending, at least partially, through the castor pads. The C-shaped beam may be arranged and attached to the castor pads such that the beam and the channel of the castor pads forms a continuous recess from a first castor pad along a channel formed by two walls of the beam extending upward from the bottom surface of the beam, forming the C-shape, such that the rolling support, when assembled, is capable of engaging a lower portion of a gondola support.

The gondola support may be raised, such as by a jack, allowing the rolling support to fit under the gondola support. The raised gondola support may be lowered into position on the shelf support member. In one example, the gondola support is horizontal to the ground and fits within the channel formed by the castor pads and a C-shaped beam mounted between the two castor pads on either end of the beam. A plurality of the rolling supports may be attached together by cross-supports. Each cross-support may be engageably attached to two castor pads of neighboring rolling supports at opposite ends of each cross-support, which may be oriented substantially transverse to the orientation of the shelf support members.

In one example, a plurality of rolling supports is each attached by a plurality of cross-supports disposed on opposite ends of the rolling supports. The length of the cross-supports may be fixed or adjustable. If fixed, the rolling supports may provide a plurality of slots or slits engageable by retainers disposed on opposite ends of each of the cross-supports.

In one example, each of the castor pads has three castors. For example, two castors may be mounted on one side of a channel formed in a castor pad, and one castor may be mounted on the opposite side of the channel.

For example, three or more rolling supports may be linked together by a plurality of cross-supports, such that each of the gondola supports of a gondola shelving system is supported by one of the rolling supports. By linking each of the gondola supports to its nearest neighboring gondola support, the system of mobilization prevents accidental separation of shelving from the supports. This system allows stocked shelving to be lifted, the rolling supports to be inserted under the gondola supports, the stocked shelving to be lowered onto the rolling supports and the rolling supports to be moved in unison, without unstocking and restocking the shelving. This system greatly reduces the need for jacks that are integrated in the supports of some other gondola support or mobilization systems, which allows the rolling supports to remain in place for longer durations without the cost of including the jacking system as an integral part of the rolling supports. In this way, the gondolas may be moved and repositioned as needed, such as during remodeling of stores or resurfacing of flooring, while the jacks used in raising and lowering the gondola supports onto the rolling supports may be used elsewhere. In addition, only one set of jacks are needed to raise and lower a gondola run onto the rolling supports.

In one example, a system for mobilizing stocked shelving comprises a plurality of shelving mobilization assemblies. Each of the plurality of shelving mobilization assemblies may comprise a support having a shelving support surface, a first end and a second end, distal from the first end, a first castor assembly, and a second castor assembly. The first castor assembly and the second castor assembly each may comprise a castor pad, for example. Each castor pad may comprise a plurality of castors and a channel defining a U-shaped cavity having a recessed support surface between two opposing walls extending upward from the recessed support surface disposed between the plurality of castors. For example, the first end of the support is adjustably insertable in the U-shaped cavity of the first castor assembly, and the second end of the support is adjustably insertable in the U-shaped cavity of the second castor assembly, such that the distance between the first castor assembly and the second castor assembly is adjustable. The stocked shelving may be capable of being mobilized by inserting the support under a portion of the stocked shelving in contact with the floor by barely lifting the stocked shelving at all. The positioning of the first end of the support in the first castor assembly may be accomplished before or after raising the stocked shelving, such as by using a lift, jack or pry bar. Likewise, the positioning of the second end of the support in the second end of the castor assembly may be accomplished before or after lifting the stocked shelving and inserting its support within the support of the assembly.

In one example, the distance between the first castor assembly and the second castor assembly is fixed, when the stocked shelving is positioned on the support, by an interlocking engagement of the support and the castor assemblies. For example, the first end of the support comprises a tab extending from the first end of the support such that the tab adjustably engages one of a plurality of slots formed in the recessed support surface of the first castor assembly, and the second end of the support may comprise another tab extending from the second end of the support such that the tab adjustably engages one of a plurality of slots formed in the recessed support surface of the second castor. Each castor assembly may comprise a plurality of castors, such as three castors. If three castors, then two castors may be disposed on one side of the channel and one castor on the opposite side of the channel from the two castors. In order to fix the width between assemblies, a tie bar having a first end and a second end may be engaged between neighboring pairs of shelving mobilization assemblies.

6. A method of mobilizing stocked shelving may include sliding the support of one of the plurality of shelving mobilization assemblies under a portion of the stocked shelving in contact with the floor by slightly raising the portion of the stocked shelving with a jack or pry bar, engaging the first end of the support in the channel of the first castor assembly, and engaging the second end of the support in the channel of the second castor assembly, such that a length one of the plurality of shelving mobilization assemblies is adjusted to support the portion of the stocked shelving. By repeating the previous steps with other shelving mobilization assemblies until each of the portions of the stocked shelving previously in contact with the floor are at least slightly raised above the floor, the entire stocked shelving unit is mobilized. For example, tying together neighboring pairs of shelving mobilization assemblies with a tie bar prevents the spacing between the neighboring pairs of shelving mobilization assemblies to change, keeping mobilization of the shelving uniform and preventing separation of shelving from supports, for example.

### BRIEF DESCRIPTION OF THE DRAWINGS

FIG. 1 illustrates an example of a plurality of rolling supports attached together by cross-supports.

FIG. 2 illustrates an example of a partially exploded view of a C-shaped beam being mounted between two castor pads.

FIG. 3 illustrates an example of the rolling support in FIG. 2 mounted between two castor pads to provide an adjustable length of a channel formed by the castor pads and the C-shaped beam.

FIG. 4 illustrates an example of a gondola support being inserted into a channel formed by a rolling support.

### DETAILED DESCRIPTION

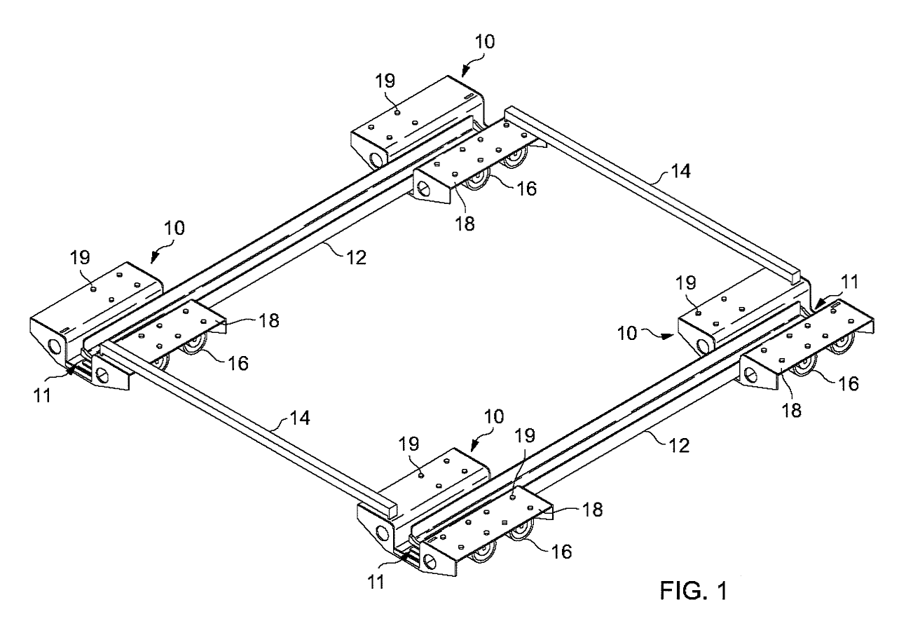

In one example, illustrated in FIGS. 1-4, a system for mobilizing stocked shelving comprises a plurality of castor pads 10 attached together by support members 12 and cross-supports 14. Each castor pad includes three castors 16 attached to a raised portion 18 of the castor pad using a plurality of bolts 19. Two of the castors 16 are disposed on one side of a channel 11 formed between two opposite raised portions 18 of each castor pad 10. The other castor 16 is disposed on the opposite side of the channel 11.

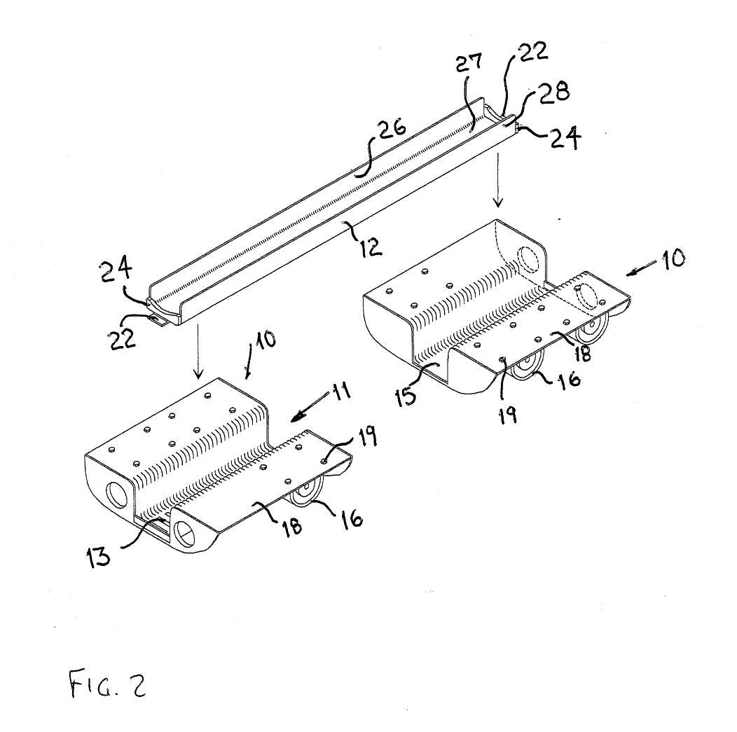

FIG. 2 shows opposite sides of identical castor pads 10 oriented to show slots or slits 13 formed in a bottom surface 15 of a channel 11 formed in each of the castor pads 10. One castor 16 is disposed on one side of the channel 11, while two castors 16 are disposed on the opposite side of the channel 11. Four bolts 19 are used to attach each castor assembly 16 to a raised portion 18 on each side of the channel 11. Each support member 12 is comprised of opposite side walls 26, 28 extending upwardly from a support surface 27 connecting the opposite side walls 26, 28 one to the other. Tabs 22 extend outwardly from end walls 24 on opposite ends of each support member 12.

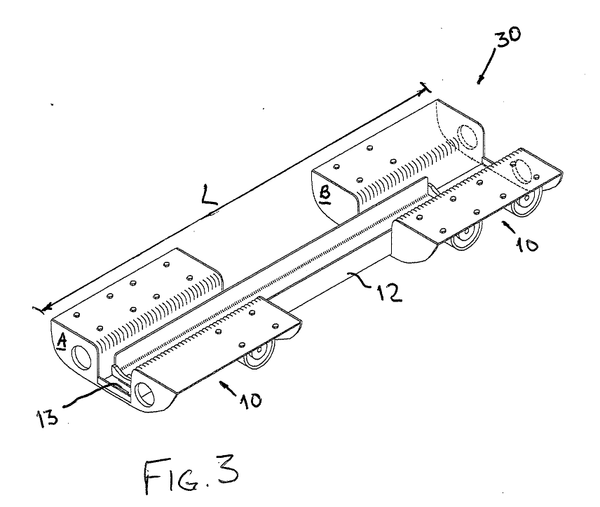

FIG. 3 illustrates an assembled rolling support 30 comprising two castor pads 10 connected by a support member 12, removably attached to each of the two castor pads 10. The length L of the rolling support 30 is adjustable by selecting the slot or slits 13 into which each end of the support member 12 is removably attached. On the first end of the rolling support A, the support member 12 is attached closer to the end A of the rolling support. The opposite end of the support member 12 is attached closer an opposite end B of a castor pad 10 on the opposite end of the rolling support 30.

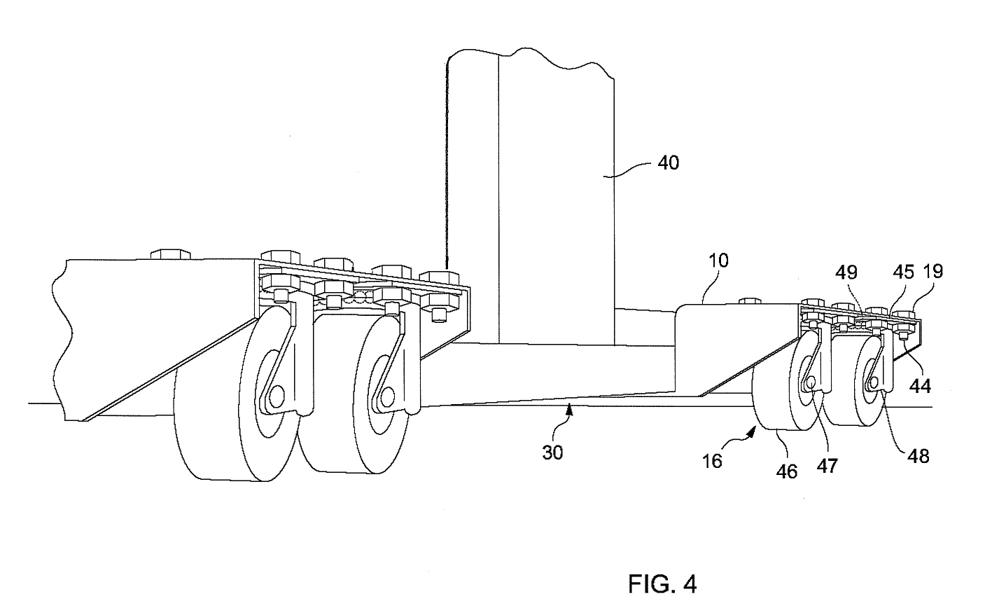

FIG. 4 illustrates a rolling support 30 disposed in a supporting position under a gondola support 40. The castor assemblies 16 are shown including a mounting plate 45 attached to the castor pad 10 by four bolts 19 and nuts 44. The axle 47 rotatably mounts the wheels 46 to support arms 48, which are pivotably mounted by castor bearings 49 to the mounting plate 45. Three castor assemblies 16 are illustrated as being attached to the castor pad 10. Two or four castor assemblies 16 may be selected, also, for each castor pad 10, but three is optimal for this application, provided that the three castor assemblies 16 are capable of supporting the estimated weight of the gondola transferred to the rolling support 30 by each gondola support 40.

What is claimed is:

1. A system for mobilizing stocked shelving, comprising
a plurality of shelving mobilization assemblies, each of the plurality of shelving mobilization assemblies comprising:
a support having a shelving support surface, a first end and a second end, distal from the first end;
a first castor assembly; and
a second castor assembly, wherein the first castor assembly and the second castor assembly each comprise:
a plurality of castors; and
a channel defining a U-shaped cavity having a recessed support surface between two opposing walls extending upward from the recessed support surface disposed between the plurality of castors; and
wherein the first end of the support is adjustably insertable in the U-shaped cavity of the first castor assembly, and the second end of the support is adjustably insertable in the U-shaped cavity of the second castor assembly, such that the distance between the first castor assembly and the second castor assembly is adjustable, such that stocked shelving is capable of being mobilized by inserting the support under a portion of the stocked shelving in contact with the floor and positioning the first end of the support in the first castor assembly and the positioning the second end of the support in the second end of the castor assembly, whereby the distance between the first castor assembly and the second castor assembly is fixed by an interlocking engagement of the support with each of the first castor assembly and the second castor assembly, when the portion of the stocked shelving is supported by the support.

2. The system of claim 1, wherein the first end of the support comprises a tab extending from the first end of the support such that the tab adjustably engages one of a plurality of slots formed in the recessed support surface of the first castor.

3. The system of claim 2, wherein the second end of the support comprises a tab extending from the second end of the support such that the tab adjustably engages one of a plurality of slots formed in the recessed support surface of the second castor.

4. The system of claim 1, wherein the plurality of castors of each of the first castor assembly and the second castor assembly is three castors, and two castors are disposed on one side of the channel and the other castor is disposed on an opposite side of the channel from the two castors.

5. The system of claim 1, further comprising a tie bar having a first end and a second end, wherein the first end of the tie bar engages one of a neighboring pair of the plurality of shelving mobilization systems and the second end of the tie bar engages the other of the neighboring pair of the plurality of shelving mobilization systems.

6. A method of mobilizing stocked shelving using the system of claim 1, comprising:
sliding the support of one of the plurality of shelving mobilization assemblies under a portion of the stocked shelving in contact with the floor by slightly raising the portion of the stocked shelving with a jack or pry bar;
engaging the first end of the support in the channel of the first castor assembly; and
engaging the second end of the support in the channel of the second castor assembly, such that a length one of the plurality of shelving mobilization assemblies is adjusted to support the portion of the stocked shelving; and
repeating the previous steps with others of the plurality of shelving mobilization assemblies until each of the portions of the stocked shelving previously in contact with the floor are at least slightly raised above the floor.

7. The method of claim 6, further comprising tying together a neighboring pair of the plurality of shelving mobilization assemblies with a tie bar such that the spacing between the neighboring pair of the plurality of shelving mobilization assemblies is fixed.

8. The method of claim 7, further comprising mobilizing the shelving while stocked.
